(19) United States
(12) Patent Application Publication
(10) Pub. No.: US 2012/0181118 A1
(43) Pub. Date: Jul. 19, 2012

(54) DEVICE FOR DISPLAYING FLOOR INFORMATION OF OPERATING ELEVATOR USING ACCELERATION SENSOR

(76) Inventors: Jae Boo Choi, Anyang (KR); Chang Joon Choi, Anyang (KR)

(21) Appl. No.: 13/497,028

(22) PCT Filed: Sep. 22, 2009
(86) PCT No.: PCT/KR2009/005390

§ 371 Date: Mar. 19, 2012

(51) Int. Cl. B66B 3/00

(52) U.S. Cl. 187/393

(57) ABSTRACT

The present invention relates to a device for displaying floor information of an operating elevator, which provides a user with information on the floor where an elevator car is positioned by operating the current position of the elevator car. The device is not electrically connected to an existing elevator driving system, so that the installation procedure of the display device is simple and easy. In addition, it is possible to realize integration even though every elevator employs protocols different from each other.

### TECHNICAL FIELD

The present invention relates to a device for displaying floor running information in an elevator using an acceleration sensor and, more particularly, to a device for displaying floor running information in an elevator for displaying and guiding running information, abnormal information, etc. by detecting and calculating the current floor (position) of the elevator in the state in which the elevator is electrically connected to or is not electrically connected to the existing internal elevator system for driving the elevator.

### BACKGROUND ART

Typically, the floor position detection device of an elevator (i.e., moving means in a high-rise building) for detecting a position value for the height of each floor and a current position according to the movement of the elevator is electrically connected to an internal system. Thus, the elevator is adjusted so that it runs to a target floor in response to the calling of each floor.

This detection device chiefly includes a kind of a mechanical switch or an optical sensor employing the transmittance and reflection of light. The detection device is connected to an external information device for displaying an operation direction and a current position in real time while moving to each floor, thus providing a user with running information about the elevator.

The external information device, however, is limited to and installed in a place where a person boards the elevator. Furthermore, as a building recently becomes high and bulky, there is a tendency that the running distance and the boarding wait time of the elevator are increased.

Accordingly, in order to reduce the boarding wait time, a person may want to know the current floor position of an elevator in other devices or other places (e.g., an office or home) outside the elevator. In the prior art, dedicated communication equipment having a protocol synchronized with a relevant elevator system must be used. Furthermore, the disclosure of data and a technical consultation with a relevant elevator manufacturer, and so on are additionally required.

Furthermore, there is a problem in a hardware connection for performing communication with various types of elevator systems manufactured by several elevator manufacturers. It is also difficult to develop a construction for enabling integral implementation which is used in different protocols for respective elevators.

In the prior art, the elevator is directly electrically connected to the elevator system and is configured to display the floor position of the elevator. Accordingly, there are a variety of problems, such as a problem in the specifications of the existing products according to an electrical connection, a problem of signal interference with the existing products, and a reliability problem in driving. For the reasons, problems arise because it is practically difficult to cooperate with elevator companies and to share technical information therewith and a lot of costs and time are required accordingly.

There is also a problem in terms of installation efficiency and costs because a task for additionally separating signals from the existing elevator is complicated and difficult. Furthermore, there is a problem in that the running of an elevator must be temporally stopped for installation.

Accordingly, there is a need for a device for displaying floor running information in an elevator, which detects and calculates the current floor of an elevator without influencing an internal system for driving the elevator and provides guidance.

### DISCLOSURE

### Technical Problem

The present invention has been made to solve the above problems, and an object of the present invention is to provide a device for displaying floor running information in an elevator, which is installed outside the elevator and configured to detect the current floor of the elevator and can be installed and operated without influencing the existing elevator driving system.

### Technical Solution

To achieve the above object, the present invention provides an elevator floor running information display device for detecting and calculating a current floor of the elevator without influencing an internal system for driving the elevator, comprising an acceleration sensor installed inside or outside the elevator and configured to measure a change of acceleration according to the vertical movement of the elevator; a running direction detection unit configured to detect a running direction state, including an ascent, descent, and stop of the elevator, based on the information from the acceleration sensor; a duration times on movement/stop calculation unit configured to calculate an acceleration duration time according to the start and movement of the elevator and a deceleration duration time according to the movement and stop of the elevator based on the information from the acceleration sensor; a movement time measurement unit configured to measure a necessary movement time taken for the elevator to move from the current floor to a next floor in a direction where the elevator is moved in each of floors where the elevator is run; a floor height difference compensation unit configured to measure and store an elevator movement duration time according to a difference in the floor height between the floors in each of the floors where the elevator is run; a position calculation unit configured to calculate a current position and running information of the elevator based on one or more pieces information, from among pieces of the information outputted from the acceleration sensor, the running direction detection unit, the duration times on movement/stop calculation unit, the movement time measurement unit, and the floor height difference compensation unit; and an output unit configured to output and display the floor position information and running information calculated by the position calculation unit.

Here, the elevator floor running information display device may further comprise a running range setting unit for setting and storing a range of floors where the elevator can be run, from all the floors where the elevator is run.

Furthermore, the acceleration sensor may comprise an operation direction adjustment unit configured to adjust a direction where the acceleration sensor is operated or to be automatically adjusted so that the acceleration according to the vertical movement of the elevator is measured although the acceleration sensor is mounted on any position inside or outside the elevator.

In addition, the position calculation unit may output relevant warning broadcasting and a relevant warning passage through the output unit if a value according to a change of an acceleration signal outputted from the acceleration sensor is a preset reference value or higher or a time when a change of the outputted acceleration signal continues is a preset reference time or lower.

Furthermore, the output unit may output arrival floor information, calculated by the position calculation unit, in the form of voice or text information when the running direction detection unit detects that the elevator is stopped.

Moreover, the elevator floor running information display device may further comprise a weight difference compensation unit for calculating a degree that the time taken for the elevator to move is delayed or shortened by comparing an average moving speed of the elevator with the information from the acceleration sensor based on a change in the total weight of the elevator according to an increase and decrease in the number of passengers in the elevator.

Furthermore, the position calculation unit may calculate the current position of the elevator by taking a compensation value of the obtained elevator movement delay time into consideration based on the information from the weight difference compensation unit in calculating the current position of the elevator and corrects an error of repeated calculation by databasing the compensation value.

In addition, the elevator floor running information display device further comprises an optical sensor installed at an upper part of a display panel for displaying the ascent and descent states of the elevator and floor information about the elevator by using the turn-on and turn-off of a plurality of light-emitting elements and configured to sense the light-emitting state of the display panel and a correction unit configured to correct position information about the elevator by using result values sensed by the optical sensor, wherein the position calculation unit corrects an error value of the current position of the elevator by incorporating floor information and running information calculation value of the elevator, calculated by the correction unit, into floor information and a running information calculation value calculated by the position calculation unit.

### Advantageous Effects

In accordance with the device for displaying floor running information in an elevator according to the present invention, there are advantages in that a process of installing the display device is simple because the display device is not electrically connected to the existing elevator driving system and the display device can be integrally implemented although different protocols are used in elevators.

Furthermore, the running information display device can be mounted without an electrical connection with the elevator driving system when the running information display device is installed inside or outside an elevator. Thus, the elevator can be run without experiencing an essential electrical safety test again for the safety running of the elevator.

Furthermore, when the running information display device is installed in an office or a living room of a home, a user can know running information about an elevator in real time through sound or an image. Accordingly, the elevator boarding wait time can be minimized.

In addition, since various current position detection means for elevators are used, another position detection means detects running information although an error or limitations occur in the operation of one position detection means. Accordingly, there is an advantage in that a vacuum in the operation of means can be minimized.

### DESCRIPTION OF DRAWINGS

FIG. 1 shows the construction of a device for displaying floor running information in an elevator according to a first embodiment of the present invention,

FIG. 2 is an external front view of a common elevator,

FIG. 3 is an enlarged view showing that an optical sensor is mounted on a display panel of FIG. 2,

FIG. 4 is a flowchart illustrating the detection of running state information in the elevator from a position calculation unit of FIG. 1,

FIG. 5 is a flowchart illustrating the detection of position information about the elevator from the position calculation unit of FIG. 1, and

FIG. 6 shows the construction of the device for displaying floor information according to a second embodiment of the present invention.

### BEST MODE

Preferred embodiments of the present invention are described in detail with reference to the accompanying drawings. Prior to the description, the terms or words used in the specification and the claims are not limited to or should not be construed as being typical or dictionary meanings, but should be construed as meanings and concepts which conform with the technical spirit of the present invention based on the principle that an inventor may properly define the concepts of the terms in order to describe his invention using the best method.

Accordingly, the embodiments described in this specification and constructions shown in the drawings illustrate only the most preferred embodiments of the present invention and do not represent the entire technical spirit of the present invention. Accordingly, it should be understood that a variety of equivalent arrangements and modifications which may replace the embodiments and the constructions may exist at the time of filing of this application.

First, the construction of a device for displaying floor running information in an elevator according to a first embodiment of the present invention is described.

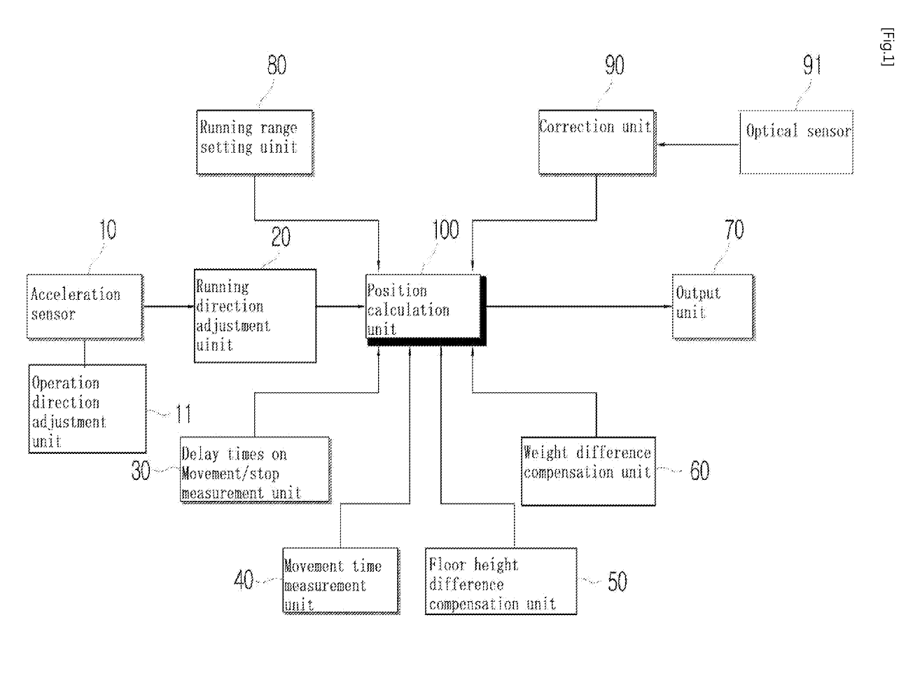

FIG. 1 shows the construction of the device for displaying floor running information in an elevator according to the first embodiment of the present invention.

As shown in FIG. 1, the device for displaying floor running information in an elevator (hereinafter referred to as the elevator floor running information display device) according to the first embodiment of the present invention includes an acceleration sensor 10, a running direction detection unit 20, a movement/stop duration times measurement unit 30, a movement time measurement unit 40, a floor height difference compensation unit 50, a weight difference compensation unit 60, an output unit 70, a running range setting unit 80, a correction unit 90, and a position calculation unit 100.

Here, the position calculation unit 100 has a function of calculating a current position and running information of the elevator on the basis of one or more pieces of information, from among pieces of output information outputted from the acceleration sensor 10, the running direction detection unit 20, the duration times on movement/stop calculation unit 30, the movement time measurement unit 40, the floor height difference compensation unit 50, the weight difference compensation unit 60, and the correction unit 90.

The calculation function of the position calculation unit 100 is described in detail below.

Meanwhile, the acceleration sensor 10 of the present invention is mounted on the inside or outside of the elevator and is configured to measure a change of acceleration (i.e., a degree that acceleration is increased and decreased) at the time of vertical movement according to the running of the elevator. The acceleration measurement value is transmitted to the running direction detection unit 20.

The acceleration measurement value of the acceleration sensor 10 is illustrated to be transmitted to only the running direction detection unit 20 in FIG. 1, but not limited thereto. The acceleration measurement value of the acceleration sensor 10 may also be selectively transmitted to the position calculation unit 100, the duration times on movement/stop calculation unit 30, the movement time measurement unit 40, the floor height difference compensation unit 50, and the weight difference compensation unit 60.

It is preferred that the acceleration sensor 10 be configured to separately measure a change of acceleration generated when the elevator ascends and a change of acceleration generated when the elevator descends.

Common acceleration sensors may be classified on the basis of the amount of an axle for a responding movement direction. The common acceleration sensors are classified into a 3-axle acceleration sensor capable of measuring acceleration for three axles for an x axle, a y axle, and a z axle, a 2-axle acceleration sensor capable of measuring acceleration for two axles predetermined from among an x axle, a y axle, and a z axle, and a 1-axle acceleration sensor capable of measuring acceleration for one axle predetermined from among an x axle, a y axle, and a z axle.

The acceleration sensors are differently used according to places where the sensors are used and use purposes. It is preferred that the acceleration sensor 10 included in the elevator floor running information display device according to the first embodiment of the present invention be the 1-axle acceleration sensor that has a relatively low price and a simple circuit construction when an economic value is taken into consideration because the acceleration sensor 10 measures only a change of acceleration according to the vertical movement of the elevator, but not limited thereto.

Accordingly, it is assumed that the acceleration sensor 10 included in the elevator floor running information display device according to the first embodiment of the present invention is a 1-axle acceleration sensor, such as that described above.

Meanwhile, it is preferred that the acceleration sensor 10 include an operation direction adjustment unit 11 for adjusting the operation direction (i.e., the direction of an axle) of the acceleration sensor 10 so that it can measure acceleration according to the vertical movement of the elevator although the acceleration sensor 10 is mounted on any position inside and outside the elevator and for automatically changing the polarity of an absolute value of output when the elevator floor running information display device is turned over and mounted.

The operation direction adjustment unit 11 has a function of automatically adjusting an operation direction where the acceleration sensor 10 is driven (i.e., an axle direction to which the acceleration sensor 10 responds) so that the operation direction is directed toward a direction where the elevator is vertically moved, such that the elevator floor running information display device according to the first embodiment of the present invention, including the acceleration sensor 10, can normally measure acceleration although the elevator floor running information display device is mounted on the surface of a wall of the elevator or on the ceiling or the bottom of the elevator.

The operation direction adjustment unit 11 further has a function of adjusting the polarity of an absolute value of output even though the elevator floor running information display device of the present invention is turned over and mounted.

For example, the acceleration sensor 10 installed on the surface of a wall of an elevator is installed so that the axle direction of the acceleration sensor 10 is identical with a direction where the elevator vertically moves when the acceleration sensor 10 is first mounted on the elevator. If the position of the acceleration sensor 10 has to move from the surface of a wall of the elevator to the ceiling or the bottom of the elevator or the acceleration sensor 10 has to have a top surface and a bottom surface turned over and installed, however, the existing axle direction is a right angle (i.e., 90°) to the direction where the elevator moves or an opposite direction to the direction where the elevator moves.

In this case, the direction where the elevator moves is made identical with the axle direction of the acceleration sensor 10 by adjusting the preset axle direction by 90° or 180° through the operation direction adjustment unit 11 so that the acceleration sensor 10 can normally measure acceleration.

Meanwhile, as described above, the acceleration sensor 10 is configured to distinguish an acceleration measurement value generated when the elevator ascends and an acceleration measurement value generated when the elevator descends from each other. The running direction detection unit 20 has a function of detecting a direction where the elevator is actually running, such as the ascent, descent, or stop of the elevator, on the basis of the acceleration measurement values according to the direction where the elevator moves.

Furthermore, the running direction detection unit 2, as described above, transmits a direction where the elevator runs, detected on the basis of the acceleration measurement value received from the acceleration sensor 10, to the position calculation unit 100.

When an elevator starts running from a stop state, the elevator slowly increases a speed on the basis of an average speed that the elevator moves, and the acceleration of the elevator is reduced before the speed reaches a specific speed, so that the speed becomes regular.

In the present invention, the time taken for the elevator to start moving and then reach the regular speed as described above is defined as an ‘acceleration duration time’, and the time taken for the elevator to reduce a speed in order to stop while moving at the regular speed and then stop is defined as a ‘deceleration duration time’.

The duration times on movement/stop calculation unit 30 has a function of calculating the acceleration duration time according to the start and movement of the elevator and the deceleration duration time according to the movement and stop of the elevator on the basis of the measurement value according to a change of acceleration that is received from the acceleration sensor 10.

Meanwhile, the movement time measurement unit 40 measures a necessary elevator movement time from a current floor to a next floor in a direction where the elevator moves in each floor where the elevator is run.

Furthermore, the floor height difference compensation unit 50 has a function of measuring and storing an elevator movement delay time according to a difference in the floor height between floors on the basis of a preset reference floor height in each floor where the elevator is run.

Here, the floor height is a distance from the bottom of a specific floor to the bottom of an upper floor or a lower floor adjacent to the specific floor. Furthermore, the reference floor height may be the height of the lowest floor, from among floors in which an elevator is run, but may be an average height of floors according to circumstances.

In addition, the movement delay time may be calculated through an experiential means or method, such as by measuring a necessary movement time between floors where an elevator is run and may be calculated on the basis of the floor height of each floor that may be known through a design drawing of a building and the moving speed of an elevator preset in an elevator driving system or the moving speed of an elevator that may be known based on acceleration information measured by the acceleration sensor 10.

Meanwhile, the running range setting unit 80 has a function of setting or storing a range of floors where the elevator can be run, from among all floors where the elevator is run.

However, an elevator driving system may be set so that the elevator does not selectively stop at the relevant floors, from among the floors of the building. Accordingly, it is preferred that the running range setting unit 80 be configured to include and store information about the floors where the elevator is not run as described above.

Here, information about the number of floors where the elevator can be run and information about floors where the elevator is not run as described above are transmitted to the position calculation unit 100.

Meanwhile, in general, in operating an elevator, if the number of passengers (including articles on board) is exceeded on the basis of a predetermined rated weight according to the use or standard of the elevator by taking the safety of passengers into consideration, the number of passengers is limited through an alarm or guidance broadcasting.

A total weight including the weight itself of an elevator that is run within a range not exceeding the rated weight may be the weight itself of the elevator when a passenger does not exist. A total weight when the elevator is full of passengers up to the rated weight may be a weight in which the weight itself of the elevator and a weight of the passengers are added.

Accordingly, when the output of a driving motor for moving the elevator in an elevator driving system is regular, there is a difference in the moving speed of the elevator between when there is no passenger and when the elevator is full of passengers. Accordingly, there is also a difference in the movement time between floors according to the difference in the moving speed.

The weight difference compensation unit 60 of the present invention is responsible for calculating the delayed movement time of an elevator according to a difference in the number of passengers.

That is, the weight difference compensation unit 60 calculates a degree that the time taken for an elevator to move is delayed or reduced by comparing an average moving speed of the elevator with a moving speed of the elevator, obtained on the basis of information received from the acceleration sensor 10, based on a change of the total weight of the elevator according to an increase and decrease of passengers who are boarding the elevator.

Here, the floor position information refers to a position of a current floor where an elevator is now placed in each of floors where the elevator is run. The running information refers to running information about an elevator, indicating a direction where the elevator is moved (i.e., whether the elevator is ascending, descending, or stopped).

Furthermore, it is preferred that the position calculation unit 100 be configured to calculate a current position of an elevator by taking a compensation value for an elevator movement delay time into consideration on the basis of result value information calculated by the weight difference compensation unit 60 when.

The position calculation unit 100 is also configured to calculate the current position of the elevator on the basis of one or more pieces of information, from among pieces of output information detected by the acceleration sensor 10, the running direction detection unit 20, the duration times on movement/stop calculation unit 30, the movement time measurement unit 40, the floor height difference compensation unit 50, the weight difference compensation unit 60, and the correction unit 90. The calculated floor position information and the running information are outputted through the output unit 70 included as additional output means.

Here, the output unit 70 may be connected to the position calculation unit 100 over a wired/wireless communication network and may be selectively installed according to a user's purpose to install an elevator in a living room within a home and a place where a person boards an elevator in an office or each floor.

A construction in which the correction unit is further included in the elevator floor running information display device according to the first embodiment of the present invention is described below.

The position calculation unit 100 of the present invention can calculate position information and running information about an elevator and provides them to a user through the output unit 70 even in the construction not including the correction unit 90 as described above.

If a building where an elevator is run is a skyscraper of 30 floor or higher, however, minute errors in output values, provided by modules (i.e., the acceleration sensor 10, the duration times on movement/stop calculation unit 30, the movement time measurement unit 40, floor height difference compensation unit 50, and the weight difference compensation unit 60), may be accumulated.

Accordingly, the position calculation unit 100 of the elevator floor running information display device according to the present invention may be configured to compensate the error value of a current position of an elevator by incorporating the floor information calculation value and running information calculation value of an elevator, calculated by the correction unit 90, into floor information and running information calculation values calculated by the position calculation unit 100.

As shown in FIG. 1, the elevator floor running information display device according to the first embodiment of the present invention may further include the correction unit 90 including an optical sensor 91.

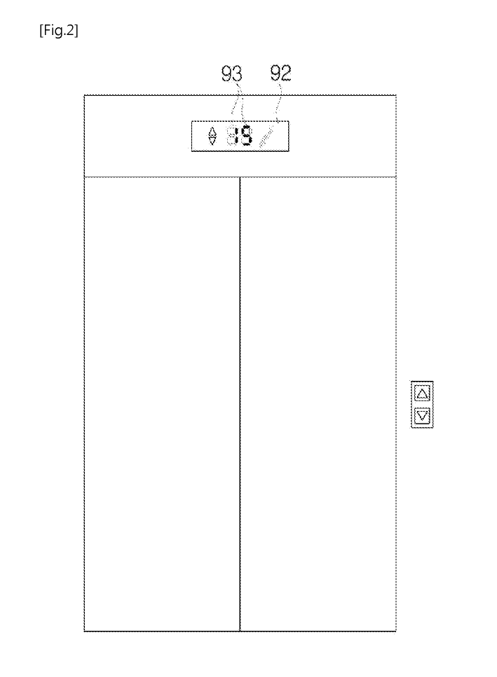

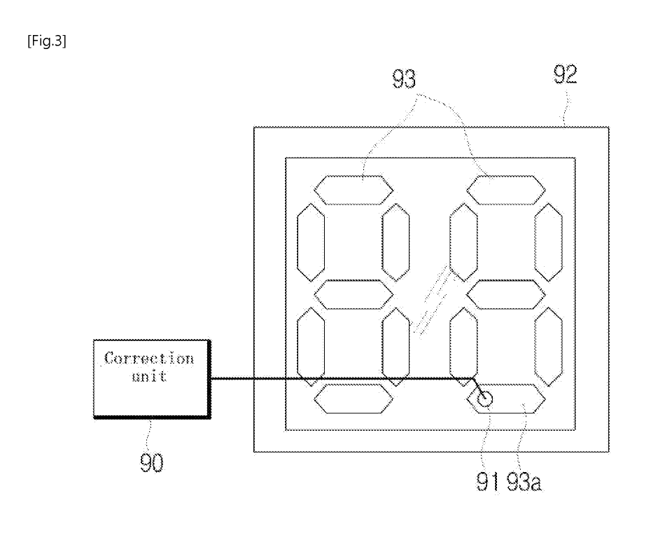

FIG. 2 is an external front view of a common elevator, and FIG. 3 is a construction showing a state in which the optical sensor 91 and the correction unit 90 are connected to a display panel of FIG. 2.

Referring to FIGS. 2 and 3, a display panel 92 for informing a user of current position information about an elevator is provided in the upper portion of the common elevator. Light-emitting elements 93, indicating position information and running information about the elevator in the form of turn-on and turn-off under the control of an elevator driving system, are provided in the upper part of the display panel 92.

The light-emitting elements 93 may be seven segment Light-Emitting Diodes (LEDs) in which one letter is composed of seven segments, as shown in FIG. 3, and may be any type of a Flat Panel Display (FPD) device whose light can be sensed externally.

Furthermore, the optical sensor 91 is installed on one side of the light-emitting elements 93 and is configured to sense whether light is emitted from each of the light-emitting elements 93. The optical sensor 91 may be installed in any one of the seven segments that may represent one letter through a combination.

In this construction, the correction unit 90 is connected to light-emitting elements 93 and the optical sensor 91. The correction unit 90 can receive a value sensed by the optical sensor 91 according to the turn-on and turn-off of the light-emitting elements 93 and calculate floor information about a position where an elevator is now placed by using a change in the light-emitting state for the selected segment which is changed based on a change in the ascent and descent of the elevator.

For example, if the optical sensor 91 is mounted on the lowest light-emitting element 93a of the seven segments as in FIG. 3, floors where the light-emitting element 93a must be turned on are each first floor, each second floor, each third floor, each sixth floor, each eighth floor, and each tenth floor (or each tenth floor, each twentieth floor, each thirteenth floor, . . . ), and floors where the light-emitting element 93a must be turned on are each first floor, each fourth floor, and each ninth floor.

Here, the correction unit 90 stores a change value in the light-emitting state of the segment for each of the floors of the elevator in the form of a database and calculates current floor information about the elevator by comparing the DB value with each of a current light-emitting state for the segment and of a light-emitting state after the elevator ascends or descends.

Accordingly, the position calculation unit 100 can correct an error value in a current position of the elevator by incorporating the elevator floor information calculation value, calculated by the correction unit 90, into the floor information calculation value and the running information calculation value calculated by the position calculation unit 100.

The operating principle that position information and running information are calculated and displayed in the elevator floor running information display device according to the first embodiment of the present invention is described below.

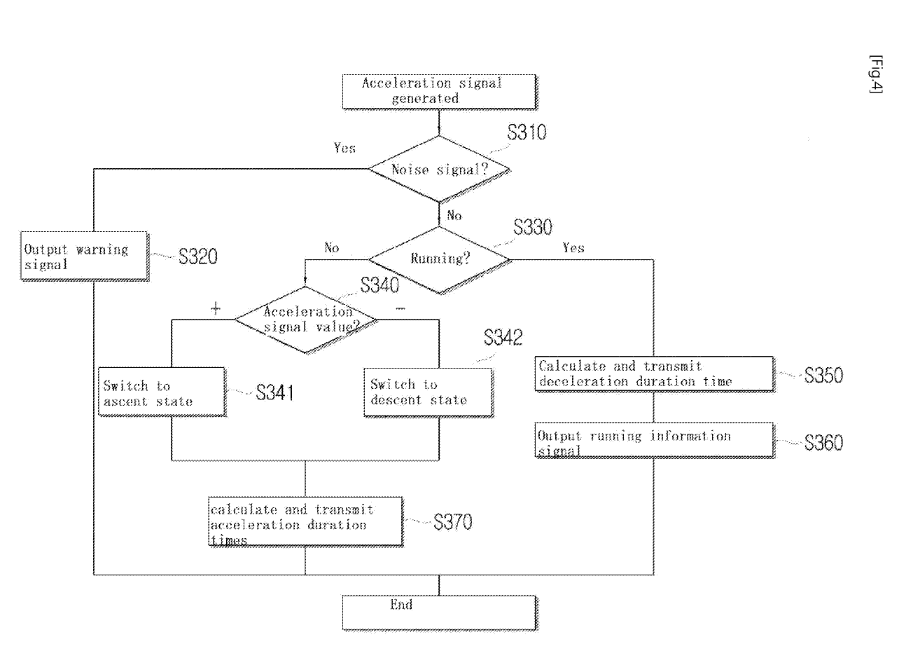

FIG. 4 is a flowchart illustrating the detection of running state information in the elevator from the position calculation unit 100 of FIG. 1. Referring to FIG. 4, when acceleration is generated or the existing acceleration measurement value is changed according to the running or stop of the elevator while the elevator is running, the acceleration sensor 10 measures the acceleration or the change of the existing acceleration measurement value and transmits a measurement value according to a change of the measured acceleration to the position calculation unit 100.

Next, the position calculation unit 100 determines whether the measurement value is a noise signal. Here, the noise signal is a measurement value for acceleration which is out of an expected range in a change of preset acceleration. (S310)

In an elevator that is normally driven, a change of acceleration measured while the elevator is running or stopped is accelerated at a regular speed, and the change reaches the moving speed of the elevator previously set in an elevator driving system. An expected range of a change in acceleration that is accelerated at a regular speed in a normal state as described above is previously measured, set, and stored in the position calculation unit 100.

If a passenger kicks the bottom of an elevator or jumps within the elevator according to circumstances while the elevator is running or a sudden descent occurs owing to an abnormal elevator driving system, the speed and acceleration of the elevator will be irregularly changed. In this case, the acceleration sensor 10 measures an instant change of acceleration, and the position calculation unit 100 determines that a measurement value out of the expected range of a change of acceleration is a noise signal, regarding the measurement value for the instant acceleration.

It is also preferred that, if the noise signal is detected, the position calculation unit 100 be configured to output a warning passage or warning broadcasting, prompting a passenger to refrain from doing an unnecessary behavior, through a warning signal output device (not shown) included in the elevator. (S320)

Meanwhile, if the acceleration signal is generated while the elevator is running belongs to the expected range of a change of the acceleration, the position calculation unit 100 determines that the acceleration signal is a change of acceleration according to a normal elevator operation and determines a current running state of the elevator (i.e., whether the elevator is moving). (S330)

If, as a result of the determination, the elevator is determined to be running, the position calculation unit 100 determines whether the acceleration signal is acceleration in an ascending direction (+) or acceleration in a descending direction (−). (S340)

Here, a criterion for determining whether the acceleration signal is acceleration in the ascending direction or acceleration in the descending direction is set on the basis of information detected by the running direction detection unit 20 as described above. Accordingly, if, as a result of the determination, the acceleration signal is determined to be acceleration in the ascending direction (+), a direction where the elevator moves is switched to an ascent state or maintained through the output unit 70 (S341). If, as a result of the determination, the acceleration signal is determined to be acceleration in the descending direction (−), a direction where the elevator moves is switched to a descent state or maintained through the output unit 70 (S342).

Next, the duration times on movement/stop calculation unit 30 calculates an acceleration duration time generated when the elevator ascends or descends and transmits the calculated acceleration duration time to the position calculation unit 100. (S370)

Furthermore, if, as a result of the determination at S330, the elevator is determined to be running, a switch of a direction where the elevator is running to a stop state is detected by the output unit 70 because acceleration has been reduced in order to stop the elevator. The duration times on movement/stop calculation unit 30 calculates a deceleration duration time according to the movement and stop of the elevator and transmits the calculation value to the position calculation unit 100. (S350)

Next, when the acceleration signal disappears, it is determined that the elevator has stopped. Thus, the position calculation unit 100 outputs a position guidance passage or guidance broadcasting for a relevant floor through a guidance signal output device (not shown) provided in the elevator. (S360)

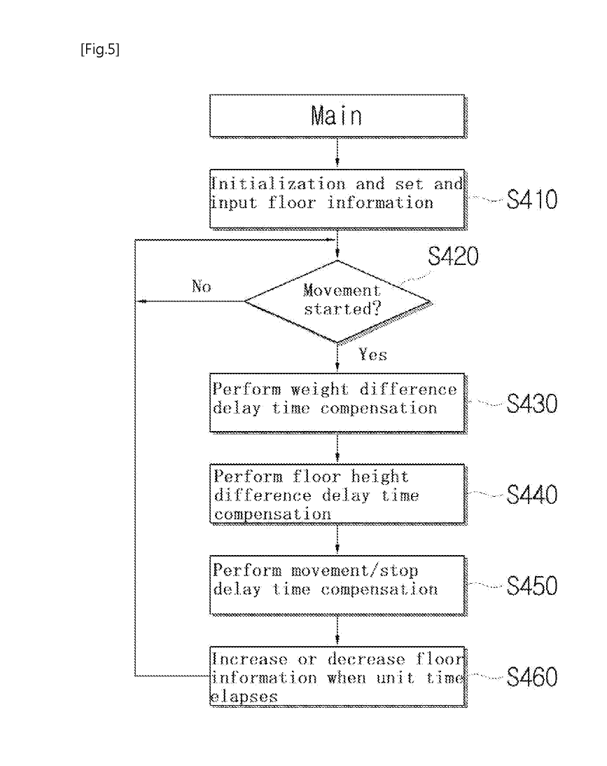

FIG. 5 is a flowchart illustrating the detection of position information about the elevator from the position calculation unit 100 of FIG. 1. Referring to FIG. 5, the elevator floor running information display device of the present invention is mounted on the inside or outside of the elevator. The elevator floor running information display device resets the display device, and floor information is set and inputted to the elevator floor running information display device. (S410)

Here, the floor information corresponds to initial input information necessary to drive the elevator floor running information display device of the present invention, such as a direction (i.e., an axle direction) where the acceleration sensor 10 is operated, the height of a floor where the elevator is running and the height of a reference floor, a moving speed of the elevator in an elevator driving system, information about floors where the elevator can be run, and an expected range of a change of acceleration.

After the initial input information is set and inputted, the position calculation unit 100 determines whether the elevator has started moving or the elevator is in a stop state on the basis of a measurement value received from the acceleration sensor 10. (S420)

If, as a result of the determination, the elevator is determined to have started, the weight difference compensation unit 60 calculates the delayed movement time of the elevator according to a difference in the number of passengers and transmits the calculated delayed movement time to the position calculation unit 100 so that the duration time according to the difference of the weight is compensated for. (S430)

Furthermore, the floor height difference compensation unit 50 measures a floor height difference delay time according to a difference in the floor height between floors where the elevator is run, stores the floor height difference delay time, and transmits the floor height difference delay time to the position calculation unit 100 so that the delay time according to the floor height difference is compensated for. (S440)

Furthermore, the duration times on movement/stop calculation unit 30 calculates an acceleration duration time according to the start and movement of the elevator or a deceleration duration time according to the stop of the elevator on the basis of an acceleration measurement value received from the acceleration sensor 10 and transmits the calculated acceleration duration time and the calculated deceleration duration time to the position calculation unit 100 so that the duration time according to the movement and the stop is compensated for. (S450)

Next, the movement time measurement unit 40 measures a necessary movement time that the elevator is taken to move from a current floor to a next floor where the elevator is stopped and transmits the measured necessary movement time to the position calculation unit 100. The position calculation unit 100 generally calculates the necessary movement time and pieces of information outputted from the weight difference compensation unit 60, the floor height difference compensation unit 50, and the duration times on movement/stop calculation unit 30 and outputs increased or decreased floor position information through the output unit 70 when a preset unit time elapses. (S460)

It is preferred that the unit time be determined by taking an average moving speed when the elevator is moving at a regular speed into consideration.

A construction of a running information display terminal according to a second embodiment of the present invention, including the elevator floor running information display device of the first embodiment, is described below.

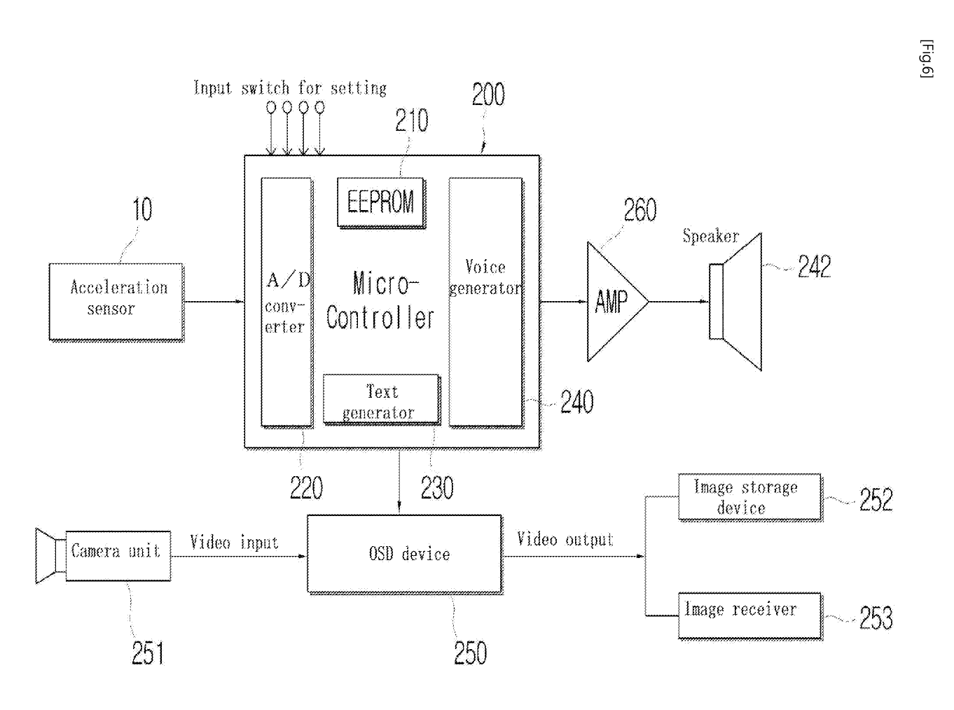

FIG. 6 is a diagram showing the construction of the running information display terminal including the elevator floor running information display device of the present invention.

Referring to FIG. 6, the running information display terminal 200 according to the second embodiment of the present invention includes all the modules, forming the elevator floor running information display device of the first embodiment, other than the output unit 70. The running information display terminal 200 further includes memory 210, an A/D converter 220, a text generator 230, a voice generator 240, an amplifier 260, a speaker 242, an OSD device 250, a camera unit 251, an image storage device 252, and an image receiver 253.

It should be understood that the speaker 242, the image storage device 252, and the image receiver 253 of the second embodiment of the present invention be elements replacing the output unit 70 of the first embodiment of the present invention and perform the same functions as the output unit 70.

The A/D converter 220 functions to convert information, outputted from the acceleration sensor 10, into a digital signal. The memory 210 stores pieces of information outputted from the modules including the position calculation unit 100 of the elevator floor running information display device according to the first embodiment of the present invention.

Furthermore, the voice generator 200 outputs the output information of the output unit 70 in the form of voice. The text generator 230 outputs the output information in the form of text. The amplifier 26 amplifies a voice signal, outputted from the voice generator 240, and transmits the amplified signal to the speaker 242.

Furthermore, the camera unit 251 captures an image inside or outside of the elevator and transmits the captured image information to the OSD device 250. The OSD device 250 functions to overlap pieces of information so that the image signal of the camera unit 251 and the output information of the text generator 230 are outputted at the same time.

The OSD device 250 outputs overlapped information and outputs the image signal to the image storage device 252 and the image receiver 253 of the present invention for enabling a user to view or check floor information.

The operating principle of the running information display terminal 200 according to the second embodiment of the present invention is described below. An acceleration measurement value outputted from the acceleration sensor 10 is converted into a digital signal through the A/D converter 220 and is then stored in the memory 210.

Furthermore, the acceleration measurement value is transmitted to the position calculation unit 100. The position calculation unit 100 receives pieces of information outputted from the modules by using the same method as the method of calculating floor position and running information in the elevator floor running information display device according to the first embodiment of the present invention, calculates the pieces of information, and transmits result values of the calculated position and running information about the elevator to the voice generator 240 and the text generator 230.

Next, the voice generator 240 transmits a voice information signal to a user on the basis of the result values so that the user can know the position and running information of the elevator in the form of voice through the amplifier 260 and the speaker.

Furthermore, the text generator 230 transmits a text information signal, overlapped with the image signal information captured by the camera unit 251 through the OSD device unit 250, to a user through the image storage device 252 and the image receiver 253 on the basis of the result values so that the user can know the position and running information of the elevator in the form of an image.

Meanwhile, the elevator floor running information display device according to the first embodiment or the second embodiment of the present invention may be applied to not only an elevator operated in a common building, such as the elevator shown in FIG. 2, but also transport equipment or a transport apparatus that is vertically moved and used in a construction site or a shipyard irrespective of elevators. The elevator floor running information display device may also display position and running information about the equipment or apparatus.

As described above, the present invention has been described in connection with the limited embodiments and the drawings, but the present invention is not limited to them and may be modified in various ways by those having ordinary skill in the art within an equivalent range of the technical spirit of the present invention and of the following claims.

### MODE FOR INVENTION

The metal substrate including the insulating layer for a high heatproof property, formed according to the present invention, has excellent characteristics, such as a resisting pressure property, a heatproof property, and heat conductivity, and has a very simple manufacture process. According to the present invention, a metal substrate including an insulating layer for a high heatproof property can be fabricated economically and efficiently.

### INDUSTRIAL APPLICABILITY

The elevator floor running information display device fabricated according to the present invention is not electrically connected to the existing elevator driving system. Accordingly, a process of installing the display device is simple and easy and can be integrally implemented although different protocols are used in elevators. In accordance with the present invention, a display device displaying floor information about an elevator can be fabricated economically and efficiently.

1. An elevator floor running information display device for detecting and calculating a current floor of the elevator without influencing an internal system for driving the elevator, the device comprising:
an acceleration sensor installed inside or outside the elevator and configured to measure a change of acceleration according to a vertical movement of the elevator;
a running direction detection unit configured to detect a running direction state, including an ascent, descent, and stop of the elevator, based on the information from the acceleration sensor;
a duration times on movement/stop calculation unit configured to calculate an acceleration duration time according to a start and movement of the elevator and a deceleration duration time according to a movement and stop of the elevator based on the information from the acceleration sensor;
a movement time measurement unit configured to measure a necessary movement time taken for the elevator to move from the current floor to a next floor in a direction where the elevator is moved in each of floors where the elevator is run;
a floor height difference compensation unit configured to measure and store an elevator movement delay time according to a difference in a floor height between the floors in each of the floors where the elevator is run;
a position calculation unit configured to calculate a current position and running information of the elevator based on one or more pieces information, from among pieces of the information outputted from the acceleration sensor, the running direction detection unit, the duration times on movement/stop calculation unit, the movement time measurement unit, and the floor height difference compensation unit; and
an output unit configured to output and display the floor position information and running information calculated by the position calculation unit.

2. The elevator floor running information display device according to claim 1, further comprising a running range setting unit for setting and storing a range of floors where the elevator can be run, from all the floors where the elevator is run.

3. The elevator floor running information display device according to claim 1, wherein the acceleration sensor comprises an operation direction adjustment unit configured to adjust a direction where the acceleration sensor is operated or to be automatically adjusted so that the acceleration according to the vertical movement of the elevator is measured although the acceleration sensor is mounted on any position inside or outside the elevator.

4. The elevator floor running information display device according to claim 1, wherein the position calculation unit outputs relevant warning broadcasting and a relevant warning passage through the output unit if a value according to a change of an acceleration signal outputted from the acceleration sensor is a preset reference value or higher or a time when a change of the outputted acceleration signal continues is a preset reference time or lower.

5. The elevator floor running information display device according to claim 1, wherein the output unit outputs arrival floor information, calculated by the position calculation unit, in a form of voice or text information when the running direction detection unit detects that the elevator is stopped.

6. The elevator floor running information display device according to claim 1, further comprises a weight difference compensation unit for calculating a degree that the time taken for the elevator to move is delayed or shortened by comparing an average moving speed of the elevator with the information from the acceleration sensor based on a change in a total weight of the elevator according to an increase and decrease in a number of passengers in the elevator.

7. The elevator floor running information display device according to claim 6, wherein the position calculation unit calculates the current position of the elevator by taking a compensation value of the obtained elevator movement delay time into consideration based on the information of the weight difference compensation unit in calculating the current position of the elevator and corrects an error of repeated calculation by databasing the compensation value.

8. The elevator floor running information display device according to claim 1, further comprising:
an optical sensor installed at an upper part of a display panel for displaying ascent and descent states of the elevator and floor information about the elevator by using a turn-on and turn-off of a plurality of light-emitting elements and configured to sense a light-emitting state of the display panel; and
a correction unit configured to correct position information about the elevator by using result values sensed by the optical sensor,
wherein the position calculation unit corrects an error value of the current position of the elevator by incorporating floor information and running information calculation value of the elevator, calculated by the correction unit, into floor information and a running information calculation value calculated by the position calculation unit.
